(19) United States
(12) Patent Application Publication
(10) Pub. No.: US 2026/0084297 A1
(43) Pub. Date: Mar. 26, 2026

(54) Automatic Teaching System and Automatic Teaching Method Thereof

(71) Applicant: BRIGHTEST TECHNOLOGY TAIWAN CO., LTD, Hsinchu County (TW)

(72) Inventors: Hsiu-Yu Lee, Hsinchu County (TW); Hao-Yu Yang, Hsinchu County (TW); Kuo-Feng Tseng, Santa Clara, CA (US)

(73) Assignee: BRIGHTEST TECHNOLOGY TAIWAN CO., LTD, Hsinchu County (TW)

(21) Appl. No.: 18/892,584

(22) Filed: Sep. 23, 2024

(51) Int. Cl. B25J 9/16; B25J 11/00; B25J 15/06; B25J 19/02

(52) U.S. Cl. CPC B25J 9/163; B25J 11/0095; B25J 15/0616; B25J 19/021

(57) ABSTRACT

An automatic teaching system configured for teaching a position of a semiconductor wafer relative to a semiconductor system includes a dummy wafer with a mark and a first sensor fixed to a first device. The semiconductor system includes the first device, which includes a holder, and a second device, which includes an end effector configured to transport the semiconductor wafer between the first device and the second device. The dummy wafer is or is to be either removed from the holder by the end effector or placed on the holder by the end effector. The first sensor is configured to determine a position of the dummy wafer by locating two opposite first edge-points of the mark after the end effector moves the dummy wafer back and forth along a first axis within the first device.

### BACKGROUND OF THE INVENTION

### 1. Field of the Invention

The present invention relates to an automatic teaching system and an automatic teaching method thereof, and more particularly, to an automatic teaching system and an automatic teaching method thereof that improve accuracy and efficiency.

### 2. Description of the Prior Art

During semiconductor manufacturing or inspection process, a semiconductor wafer may be transferred between machines. These machines, often sourced from different vendors or implemented in various ways, must be joined mechanically and calibrated to work together. This calibration, known as a teaching process, involves instructing where the wafer should be placed or transferred to. Traditionally, this teaching process is done manually, either by guiding a machine to a wafer or by guiding a machine holding a wafer to another machine, relying on visual recognition of the wafer's position. This is, however, time consuming and prone to errors. Furthermore, visually recognizing a wafer inside a machine from the outside is challenging, if not impossible. Therefore, there is room for further improvement when it comes to transferring a wafer between different machines.

### SUMMARY OF THE INVENTION

It is therefore a primary objective of the present application to provide an automatic teaching system and an automatic teaching method thereof, to improve over disadvantages of the prior art.

An embodiment of the present invention discloses an automatic teaching system, configured for teaching a position of a semiconductor wafer relative to a semiconductor system, wherein the semiconductor system comprises a first device and a second device, the first device comprises a holder, the second device comprises an end effector configured to transport the semiconductor wafer between the first device and the second device, and the automatic teaching system comprises a dummy wafer, comprising a mark, wherein the dummy wafer is or is to be either removed from the holder by the end effector or placed on the holder by the end effector; and a first sensor, fixed to the first device, configured to determine a position of the dummy wafer by locating two opposite first edge-points of the mark after the end effector moves the dummy wafer back and forth along a first axis within the first device.

Another embodiment of the present invention discloses an automatic teaching method, for teaching a position of a semiconductor wafer relative to a semiconductor system, wherein the semiconductor system comprises a first device and a second device, the first device comprises a holder, the second device comprises an end effector configured to transport the semiconductor wafer between the first device and the second device, and the automatic teaching method comprises determining, by a first sensor, a position of a dummy wafer by locating two opposite first edge-points of the mark after the end effector moves the dummy wafer back and forth along a first axis within the first device, wherein the dummy wafer is or is to be either removed from the holder by the end effector or placed on the holder by the end effector, the first sensor is fixed to the first device; and outputting, by the first sensor, information about the position of the dummy wafer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-2 are a schematic diagram of a system according to an embodiment of the present invention.

FIGS. 3-5 are schematic diagrams of a system according to another embodiment of the present invention.

FIGS. 6-8 are schematic diagrams of a system according to another embodiment of the present invention.

FIGS. 9-12 are schematic diagrams of a system according to another embodiment of the present invention.

### DETAILED DESCRIPTION

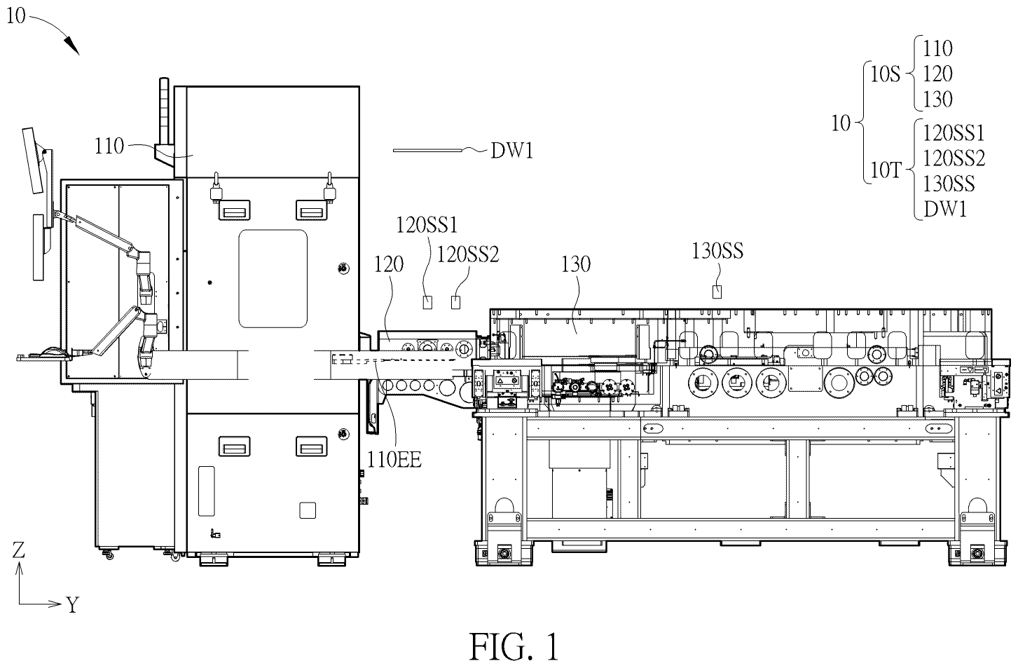

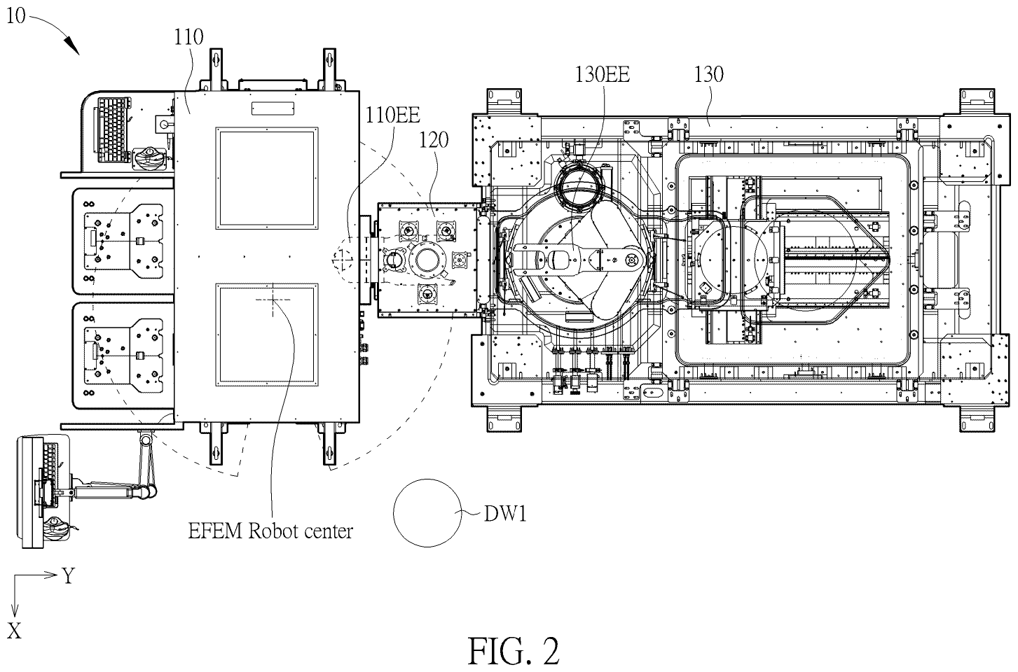

FIG. 1 is a schematic diagram of a side view of a system 10 according to an embodiment of the present invention. FIG. 2 is a schematic diagram of a top view of the system 10, which comprises an automatic teaching system 10T and a semiconductor system 10S.

The semiconductor system 10S comprises devices 110-130, one of which is configured to store, accommodate, buffer, inspect, process, or manufacture a (semiconductor) wafer. The devices 110 and 130 comprise end effectors 110EE and 130EE, respectively, to transport a wafer between the devices 110-130. The devices 110-130 may be individually implemented or manufactured (e.g., by different vendors or using different methods) before they are docked. Therefore, without prior planning or correct alignment, it is difficult for an end effector (e.g., 110EE) to accurately transfer a wafer from one device (e.g., 110) to another device (e.g., 120) after assembly.

To solve the docking issues, the automatic teaching system 10T is configured to teach where or how an end effector should move. For example, because of the automatic teaching system 10T, the end effector 110EE is able to learn where a wafer should be placed or transferred to, with respect to the device 110 or 120, with high precision.

To decrease manual operation, the automatic teaching system 10T comprises a dummy wafer DW1 and at least one sensor 120SS1, 120SS2, or 130SS for automatic locating, adjustment, or positioning.

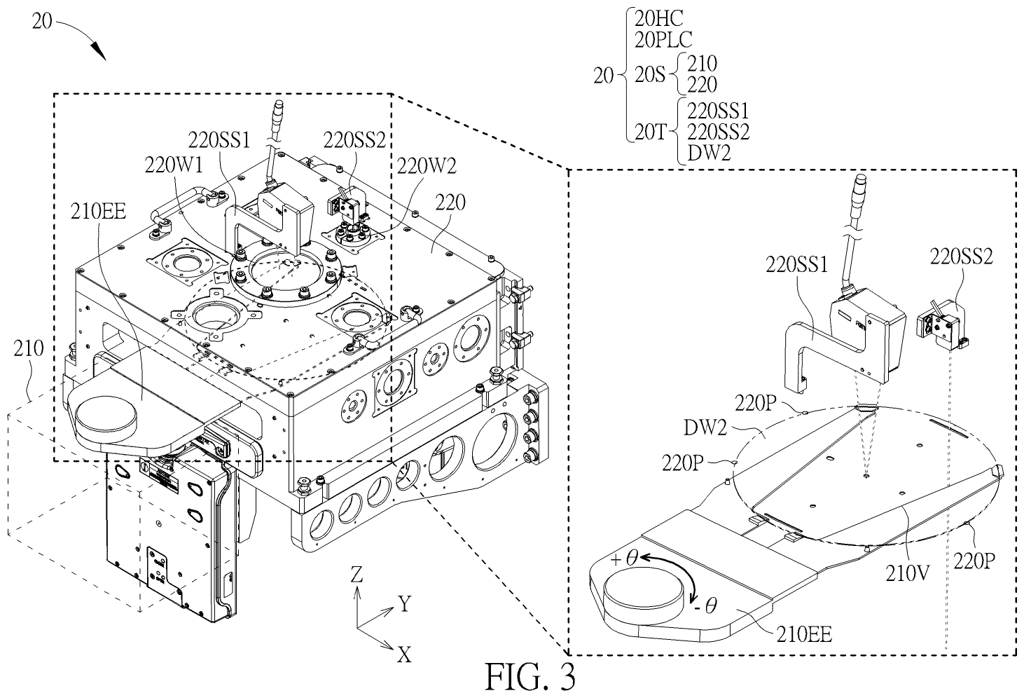

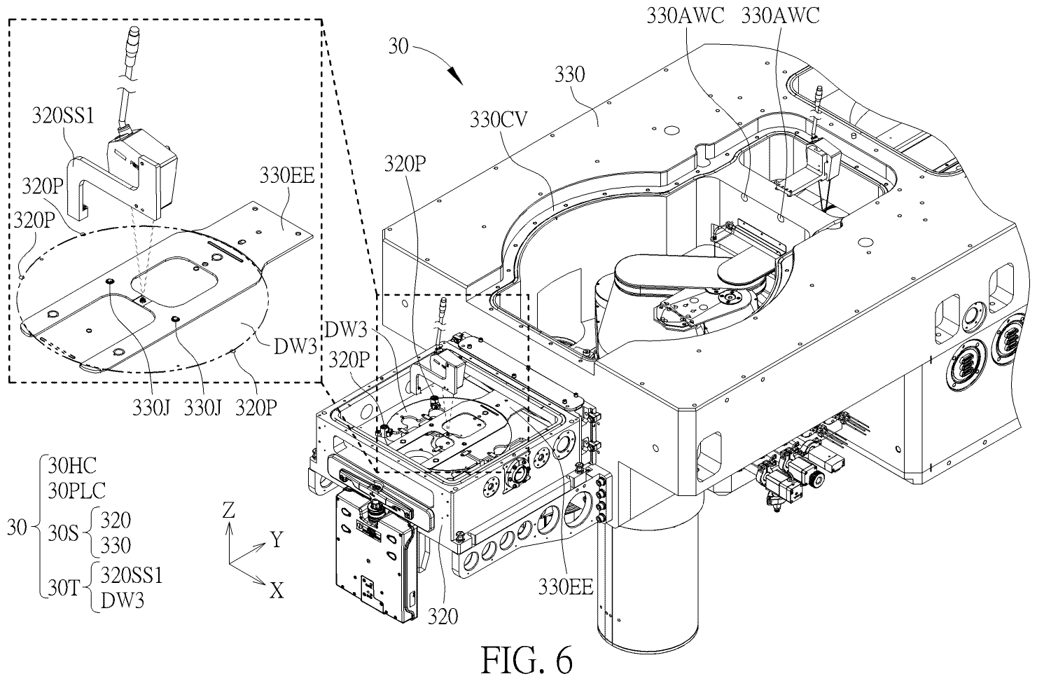

Specifically, the dummy wafer DW1 may comprise mark(s) (as shown in FIG. 6 or DW2 in FIG. 3), to facilitate easier or automatic locating or positioning. For example, when the center of the dummy wafer DW1 is moved slowly and eventually stops at a predetermined position during a teaching process, the coordinates of the predetermined position can be found more easily using a mark at the center of the dummy wafer DW1. Besides, although a mark may be larger than an ideal point with no volume or dimension, the center of the mark can be located according to at least two opposite edge-points on the symmetric mark. In contrast, an actual wafer (i.e., a semiconductor wafer), which is or will be manufactured or inspected using the semiconductor system 10S, lacks such a mark. Therefore, the dummy wafer DW1 is configured to simulate an actual wafer. The dummy wafer DW1 may have the same size or weight as an actual wafer. If the dummy wafer DW1 can be transferred to a predetermined position correctly, using the coordinates of the predetermined position, so can an actual wafer.

Similarly, an end effector (e.g., 130EE or 110EE) may be marked or cunningly leveraged to facilitate easier or automatic recognition of the position of the end effector or the dummy wafer DW1. For example, the geometric feature(s) of the end effector (e.g., an opening or a concave shape) may correspond to the mark(s) of the dummy wafer DW1 in shape, position, or size (as shown in FIG. 6 or 3).

The sensor(s) 120SS1, 120SS2, or 130SS is configured to automatically locate the dummy wafer DW1 relative to the semiconductor system 10S or automatically determining whether the dummy wafer DW1 is moved to a predetermined position (e.g., by detecting the mark(s) or the height of the dummy wafer DW1). The relative arrangement/distance between the sensor(s) and the semiconductor system 10S may be unchanged over time. For example, the sensor(s) may be fixed on the semiconductor system 10S. Since the sensor(s) and the devices 110-130 are stationary with respect to each other, the sensor(s) is able to teach where or how an end effector should move, for example, by detecting whether the dummy wafer DW1 or its the mark(s) is/are located at a predetermined position. The sensor(s) 120SS1, 120SS2, or 130SS is an optical sensor.

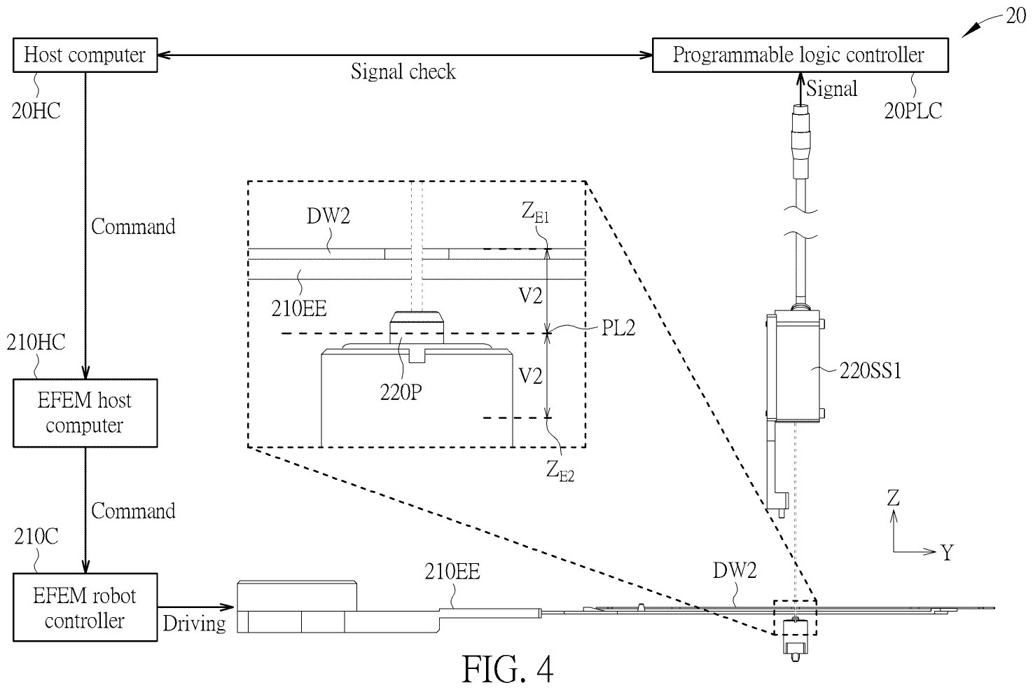

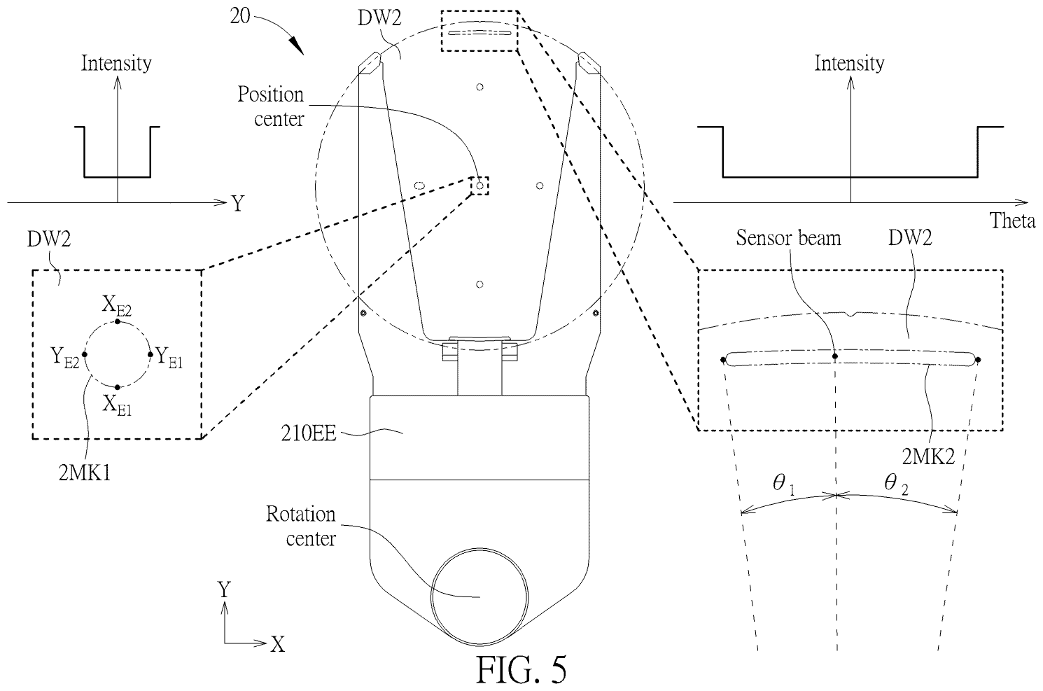

The automatic teaching system can ensure an accurate transfer of a wafer between an equipment front end module (EFEM) and a load lock. For example, FIG. 3 is a schematic diagram of a system 20 according to an embodiment of the present invention. FIG. 4 illustrates the side-view of part of the system 20. FIG. 5 illustrates the top-view of part of the system 20. A semiconductor system 20S of the system 20 comprises an EFEM 210 and a load lock 220, which may be used to implement the devices 110 and 120, respectively. An automatic teaching system 20T of the system 20 comprises sensors 220SS1, 220SS2, and a dummy wafer DW2, which may be used to implement the sensors 120SS1, 120SS2, and the dummy wafer DW1, respectively.

In an embodiment, the EFEM 210 is configured to store the dummy wafer DW2 (or a wafer) or shuffle the dummy wafer DW2 (or a wafer) between its storage carrier(s) and processing or inspect device(s). For example, an end effector 210EE of the EFEM 210 may maneuver between the interior and the exterior of the EFEM 210, to transfer the dummy wafer DW2 (or a wafer) between the EFEM 210 and the load lock 220. Corresponding to mark(s) on the dummy wafer DW2 (e.g., 2MK1 and 2MK2), the end effector 210EE comprises a geometric feature 210V, which may be the existing appearance of the end effector 210EE, a through-hole, or a non-penetrating indentation, to facilitate easier or automatic recognition of the position of the end effector 210EE or the dummy wafer DW2.

In an embodiment, the load lock 220 is a secondary vacuum chamber, configured to load the dummy wafer DW2 (or a wafer) or transfer the dummy wafer DW2 (or a wafer) between ambient air pressure condition(s) and high vacuum pressure condition(s). The load lock 220 comprises (three or more) load-lock pins 220P, which serve as a holder for the dummy wafer DW2 (or a wafer) to be placed on.

The dummy wafer DW2 comprises mark(s) (e.g., 2MK1 and 2MK2), which may be machined into the dummy wafer DW2 with high precision. As shown in FIG. 3, the mark 2MK1 or 2MK2 is a through-hole (e.g., a slit); in another embodiment, the mark 2MK1 or 2MK2 may be a non-penetrating indentation (e.g., a depression or groove). As shown in FIG. 5, the marks 2MK1 and 2MK2 are in shapes of a circle and a pill, respectively; in another embodiment, the mark 2MK1 or 2MK2 may be in a shape of a stripe, a square, or a rectangle. As shown in FIG. 5, the mark 2MK1 is located at the center and along a diameter of the dummy wafer DW2, and the mark 2MK2 is located close to the edge and perpendicular to the diameter of the dummy wafer DW2. The dummy wafer DW2, the mark 2MK1, or 2MK2 may be symmetrical to minimize directionality and enhance the accuracy of locating. However, the present invention is not limited thereto, and the number, geometry, shape, position, or size of mark(s) of the dummy wafer DW2 is adjustable. For example, the dummy wafer DW2 may comprise only one mark.

An automatic teaching method is suitable for the system 20 and may comprise the following steps:
Step S201: (Dock the load lock 220 to the EFEM 210, both of which may be maintained at an ambient air pressure.) Check if the relative positions (e.g., horizontal levels) of the EFEM 210 and the load lock 220 are correct. For example, the distance between the EFEM 210 and the load lock 220 is less than ±3 mm (millimeter).
Step S202: Mount the sensor 220SS1 or 220SS2 on the load lock 220. Check if the sensor 220SS1 or 220SS2 is functioning properly. (The sensor 220SS1 or 220SS2 may start to emit (electromagnetic) waves (e.g., laser, microwaves, ultraviolet light, infrared light, or ultrasound) or detect their reflections through windows 220W1 or 220W2 of the load lock 220, to monitor/detect the dummy wafer DW2.)
Step S203: Place the dummy wafer DW2 into a front opening unified pod (FOUP) of the EFEM 210. An EFEM controller 210C of the EFEM 210 controls the end effector 210EE to pick up the dummy wafer DW2 from the FOUP.
Step S204: Check if a gate valve of the load lock 220 is open. The EFEM controller controls the end effector 210EE to slowly move the dummy wafer DW2 toward (e.g., the center of) the load-lock pins 220P without colliding with other components of the end effector 210EE or the load lock 220.
Step S205: The EFEM controller 210C controls the end effector 210EE to move the dummy wafer DW2 until one (electromagnetic) wave from the sensor 220SS1 is directed at the mark 2MK1 of the dummy wafer DW2 and another wave from the sensor 220SS2 is directed at the mark 2MK2 of the dummy wafer DW2. For example, when the light emitted by the sensor 220SS1 or 220SS2 is aligned with or passes through the mark 2MK1 or 2MK2, the sensor 220SS1 or 220SS2 may output non-edge indication(s).

In other words, the wave(s) may indicate a predetermined position (e.g., the center line of the load-lock pins 220P). For example, as shown in FIG. 4, a wave from the sensor 220SS1 may propagate substantially along the center line of the load-lock pins 220P. Alternatively, as shown in FIG. 3, the reflection point of a wave from the sensor 220SS1 may be substantially located on the center line of the load-lock pins 220P and near a plane, which is parallel to surfaces of all the load-lock pins 220P. When the wave(s) is/are directed at the mark 2MK1 or 2MK2 in Step S205, the dummy wafer DW2 is at or near the predetermined position.

To accurately locate or position the dummy wafer DW2, the position of the sensor 220SS1 or 220SS2 relative to the load lock 220 may correspond to the relative position of the mark 2MK1 or 2MK2 relative to the dummy wafer DW2. For example, the wave from the sensor 220SS1 is aimed at the center line of the load-lock pins 220P, and the mark 2MK1 is located at the center of the dummy wafer DW2.

For the sensors 220SS1 and 220SS2 to roughly locate the dummy wafer DW2 at a time in Step S205, the distance between (the waves of) the sensors 220SS1 and 220SS2 may be equal to the distance between the marks 2MK1 and 2MK2.
Step S206: The EFEM controller 210C controls the end effector 210EE to move the dummy wafer DW2 in the +Y direction until the wave from the sensor 220SS1 just leaves the mark 2MK1 of the dummy wafer DW2. For example, when the light from the sensor 220SS1 just skims an edge-point of the mark 2MK1 (on the left side in FIG. 5), the sensor 220SS1 may output an edge indication, and the Y coordinate of the end effector 210EE is recorded (e.g., in an EFEM host computer 210HC of the EFEM 210) as Y_{E1}. Similarly, the end effector 210EE moves the dummy wafer DW2 in the −Y direction until the light from the sensor 220SS1 just skims the opposite edge-point of the mark 2MK1 (on the right side in FIG. 5). Corresponding to the edge-point, the sensor 220SS1 may output another edge indication, and the Y coordinate of the end effector 210EE is recorded as Y_{E2}.

The edge indication may be implemented in various ways. For example, when the sensor 220SS1, functioning as a distance or height detection sensor, detects a significant change, the controller 210PLC determines that the sensor 220SS1 outputs an edge indication. Alternatively, when a value detected by the sensor 220SS1 is equal to, more than, or less than a preset threshold, a programmable logic controller (PLC) 210PLC of the system 20 determines that the sensor 220SS1 outputs an edge indication. Alternatively, when a value/intensity detected by the sensor 220SS1 rises/drops rapidly (FIG. 5), reaches half of the maximum, or remains unchanged, the controller 210PLC determines that the sensor 220SS1 outputs an edge indication. Alternatively, when a value detected by the sensor 220SS1 is much greater than 0 or non-measurable due to no wave reflection, the controller 210PLC determines that the sensor 220SS1 outputs an edge indication. Alternatively, when the sensor 220SS1 is inactivated or turned off, the controller 210PLC determines that the sensor 220SS1 outputs an edge indication.
Step S207: The EFEM controller 210C controls the end effector 210EE to move the dummy wafer DW2 in the +X direction until the wave from the sensor 220SS1 just skims an edge-point of the mark 2MK1 (at the bottom in FIG. 5). Corresponding to the edge-point, the sensor 220SS1 may output another edge indication, and the X coordinate of the end effector 210EE is recorded (e.g., in the EFEM host computer 210HC) as X_{E1}. Similarly, the end effector 210EE moves the dummy wafer DW2 in the −X direction until the wave from the sensor 220SS1 just skims the opposite edge-point of the mark 2MK1 (at the top in FIG. 5). Corresponding to the edge-point, the sensor 220SS1 may output another edge indication, and the X coordinate of the end effector 210EE is recorded as X_{E2}.
Step S208: The EFEM host computer 210HC determines that the X and Y coordinates (X_{E}, Y_{E}) of the end effector 210EE, for transferring the dummy wafer DW2 to the load-lock pins 220P, are the average of the X coordinates X_{E1}, X_{E2} having been recorded and the average of the Y coordinates Y_{E1}, Y_{E2} having been recorded. For example, it satisfies

$$( {X}_{E ,} {Y}_{E} ) = ( \frac{{X}_{E 1} + {X}_{E 2}}{2} , \frac{{Y}_{E 1} + {Y}_{E 2}}{2} ) .$$

The X and Y coordinates (X_{E}, Y_{E}) may correspond to the center of the load-lock pins 220P.

In other words, although the mark 2MK1 may be larger than an ideal point without dimension, the center of the mark 2MK1 may be located according to at least two opposite edge-points on the mark 2MK1. For example, the X and Y coordinates of the center of the mark 2MK1 is a function of the X and Y coordinates of the at least two opposite edge-points.
Step S209: The EFEM controller 210C moves the end effector 210EE to the position

$$( \frac{{X}_{E 1} + {X}_{E 2}}{2} , \frac{{Y}_{E 1} + {Y}_{E 2}}{2} )$$

without changing its height. The EFEM controller 210C controls the end effector 210EE to rotate in the ±θ direction until the wave from the sensor 220SS2 just leaves the mark 2MK2 of the dummy wafer DW2. For example, when the light from the sensor 220SS2 just skims an edge-point of the mark 2MK2 (on the left side in FIG. 5), the sensor 220SS2 may output an edge indication, and the polar coordinate of the end effector 210EE is recorded (e.g., in the EFEM host computer 210HC) as θ₁. Similarly, the end effector 210EE rotates in the −θ direction until the wave from the sensor 220SS2 just skims the opposite edge-point of the mark 2MK2 (on the right side in FIG. 5). Then, the sensor 220SS2 may output another edge indication, and the polar coordinate of the end effector 210EE is recorded as θ₂.
Step S210: The EFEM host computer 210HC determines that the polar coordinate θ_{E} of the end effector 210EE, for transferring the dummy wafer DW2 to the load lock 220, is the average of the polar coordinates θ₁ and θ₂ having been recorded. For example, it satisfies

$${θ}_{E} = \frac{{θ}_{1} + {θ}_{2}}{2} .$$

In other words, when an end effector (e.g., 210EE) is capable of rotating or has already been rotated, a sensor (e.g., 220SS2), which functions as an angle teaching sensor, may be added in the automatic teaching system 20T.

The shape or the position of the mark 2MK2 is meticulously designed to optimize its function. For example, because the mark 2MK2 is configured to measure angles, the mark 2MK2 is positioned further than the mark 2MK1 with respect to the rotation center of the end effector 210EE or extended (to be longer than the mark 2MK1) in the direction perpendicular to the radius of the dummy wafer DW2, so as to increase the range of angles that can be measured. Alternatively, the mark 2MK2 may take the form of a concentric ring, sharing the same center as the rotation of the end effector 210EE (i.e., the rotation center).
Step S211: The EFEM host computer 210HC repeats Steps S206-S208 without changing the polar coordinate θ_{E}, to obtain the updated X and Y coordinates (X′_{E}, Y′_{E}) of the end effector 210EE, for transferring the dummy wafer DW2 to the load lock 220.
Step S212: The EFEM host computer 210HC initially sets a passline PL2 when the value of the dummy wafer DW2 detected by the sensor (e.g., 220SS1) is 0 mm. The passline PL2 serves as a baseline for an initial height of the end effector 210EE. The EFEM controller 210C then controls the end effector 210EE to move in the +Z direction to a position upper limit Z_{E1} (at the top in FIG. 4), where the value detected by the sensor (220SS1) is −V2 (e.g., −4 mm). Since the sensor (220SS1) only detects the upper surface of the dummy wafer DW2, the end effector 210EE cannot move the dummy wafer DW2 directly to a position lower limit Z_{E2}, which is below the (top) surfaces of the load-lock pins 220P for holding the dummy wafer DW2. Given that the total path length is 2×V2 (e.g., 8 mm), the position lower limit Z_{E2} is set when the value detected by the sensor (220SS1) should be +V2 (e.g., +4 mm). For example, the position lower limit Z_{E2} may be calculated according to (the Z coordinate of) the passline PL2 and the position upper limit Z_{E1}.

In other words, the sensor 220SS1 may serve as a distance or height detect sensor to measure the height of the dummy wafer DW2 or Z coordinates (e.g., Z_{E1}) of the end effector 210EE. In FIG. 4, the sensor 220SS1, which focuses on the center of the load-lock pins 220P, is used to perform height measurement in Step S212; however, the height measurement may be conducted using the sensor 220SS2.
Step S213: The EFEM host computer 210HC determines the exchange path. To place the dummy wafer DW2 on the load-lock pins 220P, the coordinates of the end effector 210EE is changed from (X′_{E}, Y′_{E}, Z_{E1}, θ_{E}) to (X′_{E}, Y′_{E}, Z_{E2}, θ_{E}). To remove the dummy wafer DW2 from the load-lock pins 220P, the coordinates of the end effector 210EE is changed from (X′_{E}, Y′_{E}, Z_{E2}, θ_{E}) to (X′_{E}, Y′_{E}, Z_{E1}, θ_{E}). The end effector 210EE may load/unload the dummy wafer DW2 onto/from the load-lock pins 220P again, to check the overall movements.
Step S214: (Remove the sensor 220SS1 or 220SS2 from the load lock 220.)

The order of Steps S201-S214 may be rearranged, and at least one of Steps S201-S214 or part of a step may be omitted.

The number of sensor(s) may be equal to or less than the number of mark(s) of the dummy wafer DW2. However, the present invention is not limited thereto, and the number, position, geometry, function, or mechanism of sensor(s) is adjustable. For example, the automatic teaching system 20T may comprise only one sensor.

In another aspect, the automatic teaching system 20T automatically provides information about a wafer target position, such that the EFEM 210 is able to instruct the end effector 210EE to accurately move the dummy wafer DW2 to the wafer target position relative to the load lock 220. Specifically, in the automatic teaching method, the end effector 210EE moves the dummy wafer DW1 slowly to predetermined position(s). The sensor 220SS1 or 220SS2 keeps detecting the dummy wafer DW2, and eventually provides the coordinates of the predetermined position(s). The predetermined position(s) may comprise the wafer target position or can be used to calculate the wafer target position: For example, the wafer target position is a function of the predetermined position(s) (e.g., the average). Then, a device target position of the end effector 210EE, which is configured for the end effector 210EE to move the dummy wafer DW2 to the wafer target position, is obtained. In other words, the coordinates of the device target position is learned by the semiconductor system 20S. Using the coordinates of the device target position, the semiconductor system 20S is able to move the dummy wafer DW2 or an actual wafer to the wafer target position.

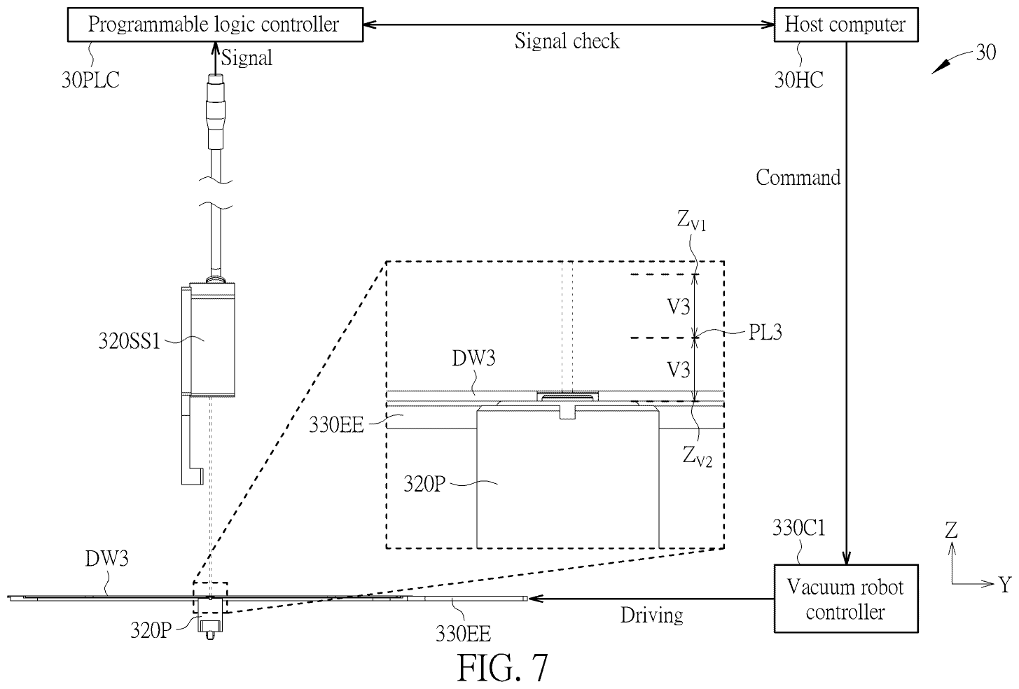

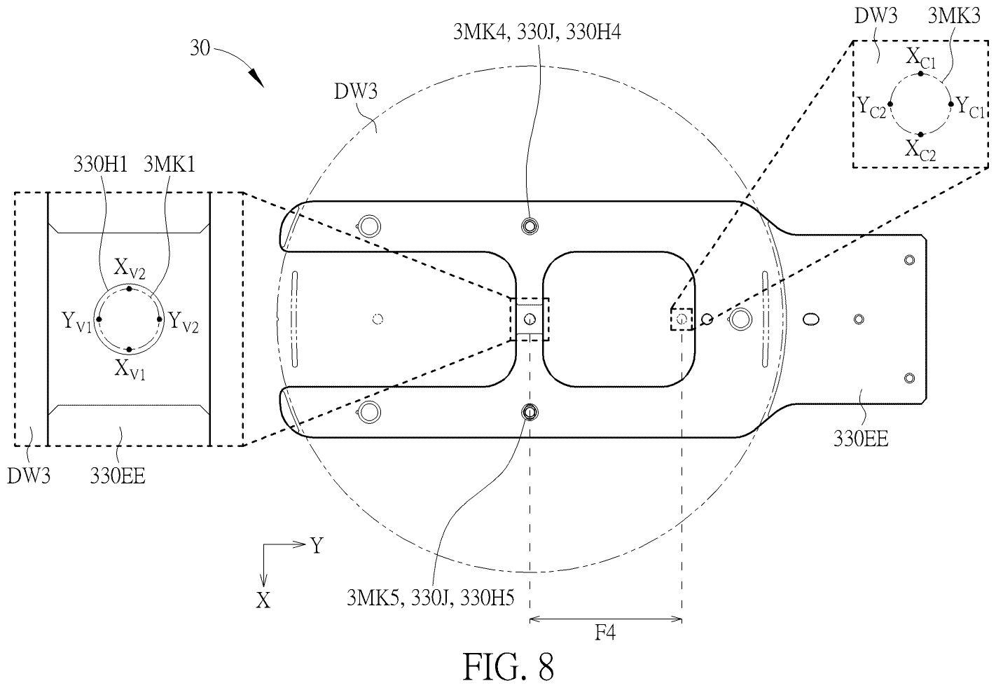

The automatic teaching system can ensure an accurate transfer between a load lock and an inspection device. For example, FIG. 6 is a schematic diagram of a system 30 according to an embodiment of the present invention. FIG. 7 illustrates the side-view of part of the system 30. FIG. 8 illustrates the top-view of part of the system 30. A semiconductor system 30S of the system 30 comprises a load lock 320 and an inspection device 330, which may be used to implement the devices 120 (or 220) and 130, respectively. An automatic teaching system 30T of the system 30 comprises sensor 320SS1 and a dummy wafer DW3, which may be used to implement the sensor 120SS1 (or 220SS1) and the dummy wafer DW1 (or DW2), respectively.

In an embodiment, the inspection device 330 is configured to verify the accuracy and functionality of a wafer and operates in an extremely clean vacuum condition. The inspection device 330 comprises an end effector 330EE, which is configured to transfer the dummy wafer DW3 (or a wafer) between the load lock 320 and the inspection device 330. Corresponding to mark(s) on the dummy wafer DW3 (e.g., 3MK1), the end effector 330EE comprises geometric feature(s) (e.g., 330H1), which may be a through-hole or a non-penetrating indentation, to facilitate easier or automatic recognition of the position of the end effector 330EE or the dummy wafer DW3.

An automatic teaching method is suitable for the system 30 and may comprise the following steps:
Step S301: (Dock the inspection device 330 to the load lock 320, both of which may be maintained at an ambient air pressure.) Check if the end effector (e.g., 110EE or 210EE) of an EFEM has left the load lock 320 or moved back to its home position. Check if a gate valve for the inspection device 330 is open.
Step S302: (Mount the sensor 320SS1 on the load lock 320, and check the functionality of the sensor 320SS1.) Check if vacuum robot auto wafer centering (AWC) function sensor(s) 330AWC for the load lock 320 is/are functioning properly.
Step S303: Remove a vacuum robot maintain cover 330CV for a window of the inspection device 330. Place vacuum robot jig(s) 330J and the dummy wafer DW3 on the end effector 330EE, such that mark(s) (e.g., 3MK1, 3MK4 or 3MK5) of the dummy wafer DW3 is aligned with the geometric feature(s) (e.g., 330H1, 330H3 or 330H4) of the end effector 330EE (FIG. 8).

In an embodiment, a dummy wafer (e.g., DW3) cannot be secured independently on an end effector (e.g., 330EE), it may require the use of vacuum robot jig(s) (e.g., 330J) to secure the dummy wafer (DW3) to the end effector (330EE). The size or shape of a vacuum robot jig (330J) corresponds to the size or shape of a mark (e.g., 3MK4 or 3MK5) on the dummy wafer (DW3) or the size or shape of a geometric feature (e.g., 330H3 or 330H4) on the end effector (330EE). For example, the size of a vacuum robot jig is substantially equal to or smaller than that of a mark or a geometric feature. A vacuum robot jig (330J) may be rod-shaped and have multiple cross-sectional areas. For example, the vacuum robot jig (330J) has a first cross-sectional area, to secure to a mark (e.g., 3MK1) of the dummy wafer DW3, and a second cross-sectional area, to secure to a geometric feature (e.g., 330H1) of the end effector 330EE. The first or second cross-sectional area may gradually change in size.
Step S304: Check if a gate valve of the load lock 320 is open. A vacuum robot controller 330C1 of the inspection device 330 controls the end effector 330EE to slowly move the dummy wafer DW3 toward (e.g., the center of) load lock pins 320P of the load lock 320 without collision.
Step S305: The vacuum robot controller 330C1 controls the end effector 330EE to move until a wave from the sensor 320SS1 is aligned with or passed through the mark 3MK1 or the geometric feature 330H1. When the wave(s) is/are directed at the geometric feature 330H1 or the mark 3MK1, which may be used to implement the mark 2MK1, in Step S305, the dummy wafer DW3 is at or near (e.g., the center of) the load lock pins 320P.
Step S306: The vacuum robot controller 330C1 controls the end effector 330EE to move the dummy wafer DW3 back and forth along the Y axis within the load lock 320, such that a host computer 30HC of system 30 can locate two opposite edge-points of the mark 3MK1 according to edge indications of the sensor 320SS1. The Y coordinates of the end effector 330EE, corresponding to the two opposite edge-points, are recorded (e.g., in the host computer 30HC) as Y_{V1} and Y_{V2}.
Step S307: The vacuum robot controller 330C1 controls the end effector 330EE to move the dummy wafer DW3 back and forth along the X axis, such that the host computer 30HC can locate two opposite edge-points of the mark 3MK1 according to edge indications of the sensor 320SS1. The X coordinates of the end effector 330EE, corresponding to the two opposite edge-points, are recorded (e.g., in the host computer 30HC) as X_{V1} and X_{V2}.
Step S308: The host computer 30HC determines that the X and Y coordinates (X_{V}, Y_{V}) of the end effector 330EE, for transferring the dummy wafer DW3 to the load-lock pins 220P, are the average of the X coordinates X_{V1}, X_{V2} and the average of the Y coordinates Y_{V1}, Y_{V2}. For example, it satisfies

$$( {X}_{V} , {Y}_{V} ) = ( \frac{{X}_{V 1} + {X}_{V 2}}{2} , \frac{{Y}_{V 1} + {Y}_{V 2}}{2} ) .$$

Step S309: The distance between the sensor 320SS1 and the dummy wafer DW3 meets a predetermined value when the value of the dummy wafer DW3 detected by the sensor 320SS1 is 0 mm. The host computer 30HC sets a passline PL3 for the distance. The host computer 30HC controls the end effector 330EE to move in the +Z direction to a position upper limit Z_{V1}, where the value detected by the sensor 320SS1 is −V3 (e.g., −4 mm). The distance corresponding to the position upper limit Z_{V1} is the predetermined value minus an offset value. Given that the total path length is 2×V3 (e.g., 8 mm), a position lower limit Z_{V2} is set when the value detected by the sensor 320SS1 should be +V3 (e.g., +4 mm). The distance corresponding to the position lower limit Z_{V2} is the predetermined value plus the offset value.
Step S310: The host computer 30HC determines the exchange path of the end effector 330EE. The coordinates of the end effector 330EE is changed between (X_{V}, Y_{V}, Z_{V1}) and (X_{V}, Y_{V}, Z_{V2}) to place/remove the dummy wafer DW3 on/from the load-lock pins 220P. The end effector 330EE may load/unload the dummy wafer DW3 again to check the overall movements. The polar coordinate of the end effector 330EE may be corrected by means of the vacuum robot AWC function sensor(s) 330AWC.
Step S311: (Remove the vacuum robot jig(s) 330J from the end effector 330EE. Remove the sensor 320SS1 from the load lock 320.)

The order of Steps S301-S311 may be rearranged, and at least one of S301-S311 or part of a step may be omitted.

The host computer 30HC may be or be used to implement the host computer 20HC.

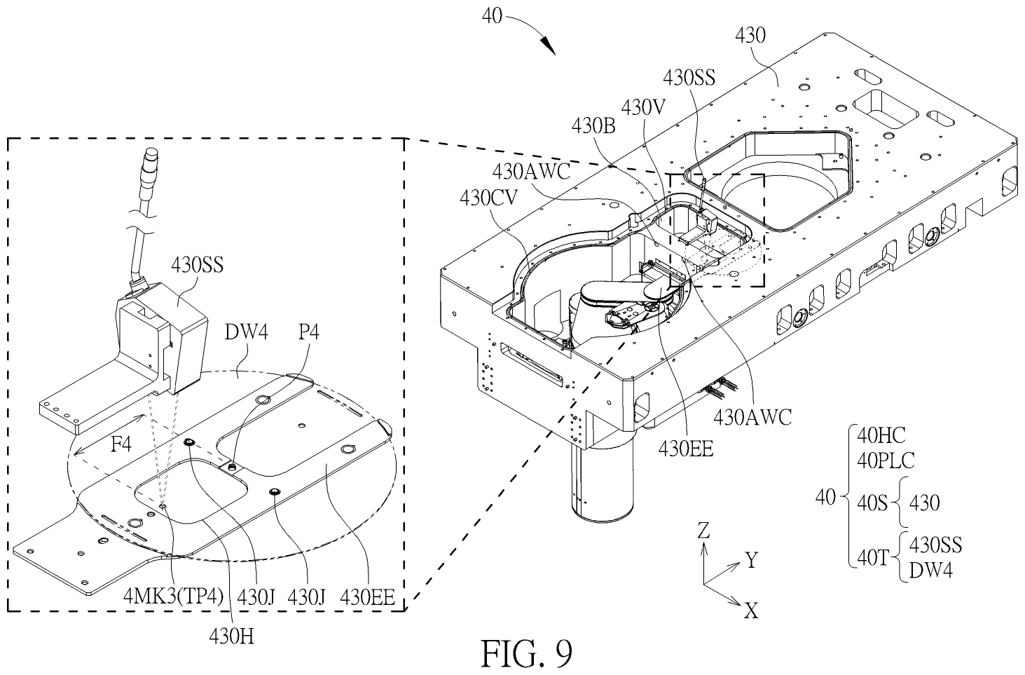

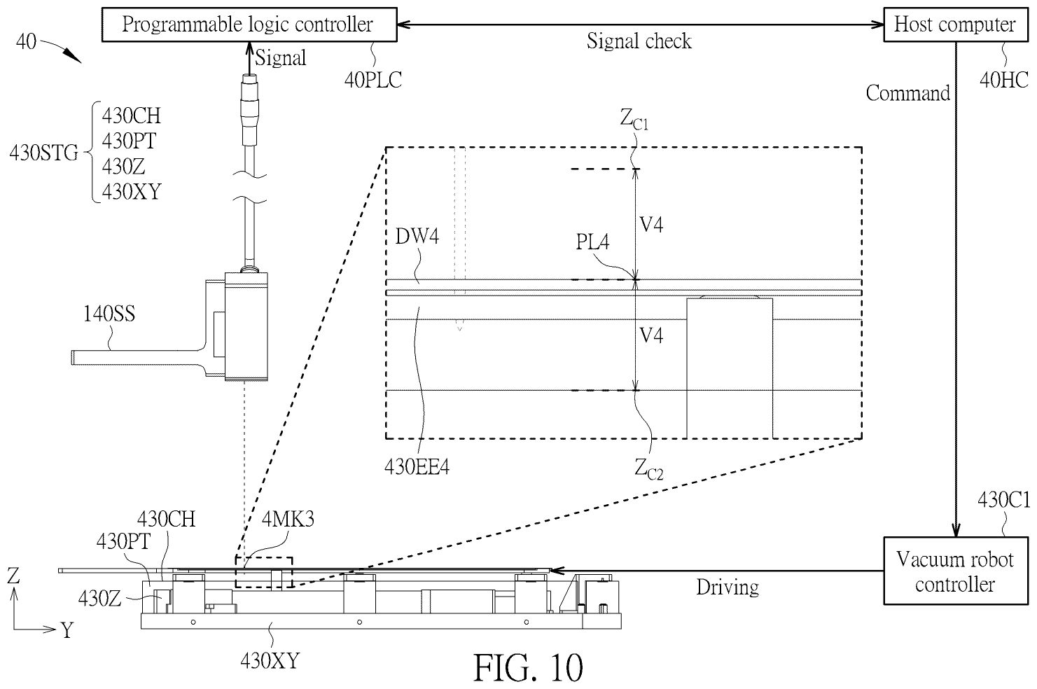

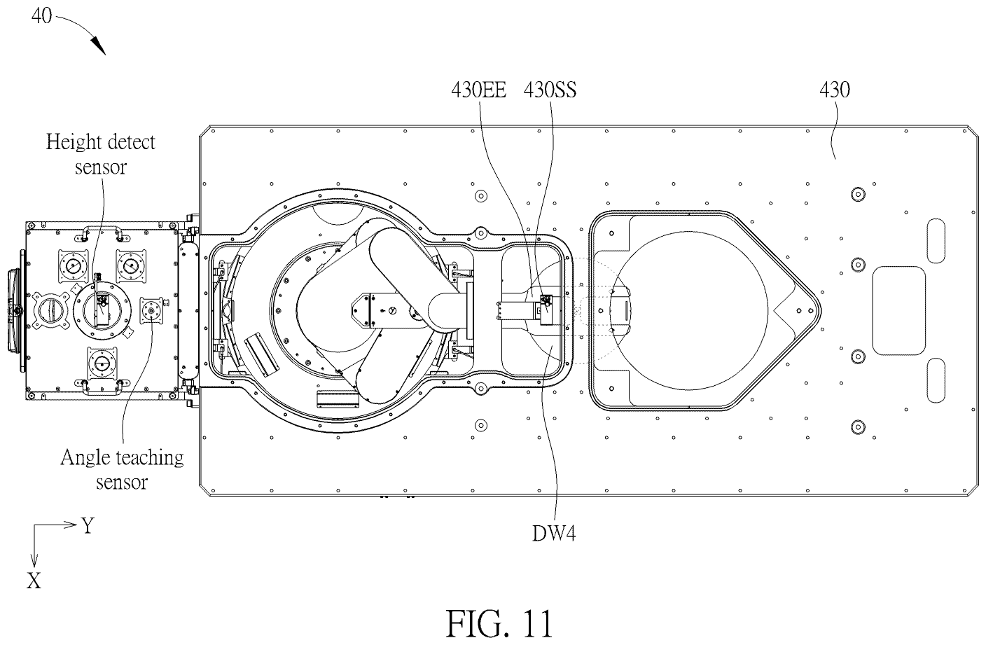

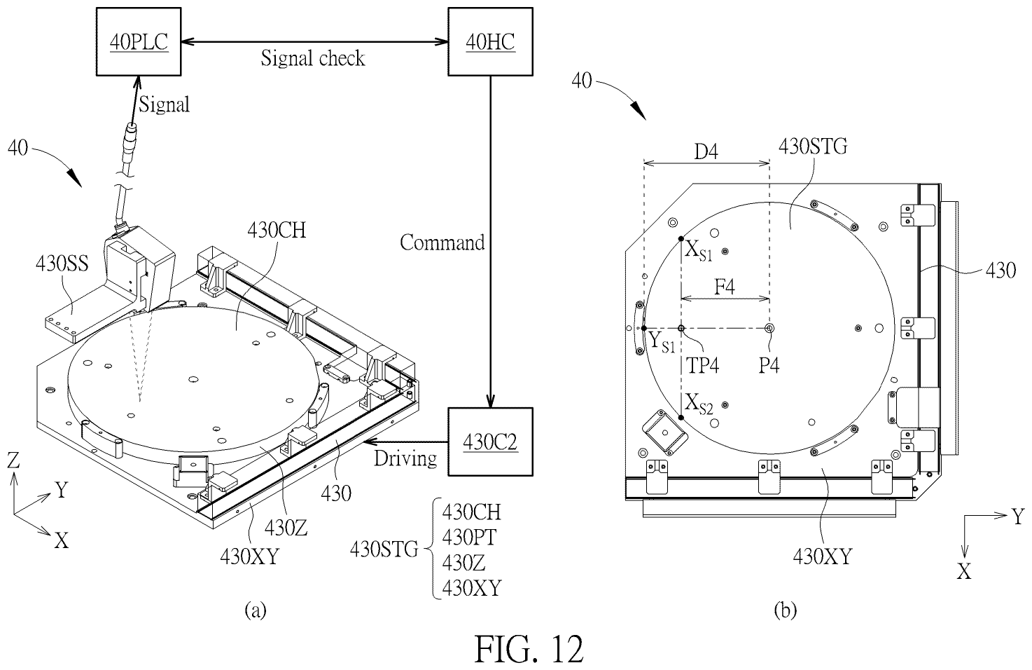

The automatic teaching system can ensure an accurate transfer in an inspection device. For example, FIG. 9 is a schematic diagram of a system 40 according to an embodiment of the present invention. FIG. 10 illustrates the side-view of part of the system 40. FIG. 11 illustrates the top-view of part of the system 40. FIG. 12 (a) illustrates part of the system 40. FIG. 12 (b) illustrates the top-view of part of the system 40. A semiconductor system 40S of the system 40 comprises an inspection device 430, which may be used to implement the device 130 (or 330). An automatic teaching system 40T of the system 40 comprises sensor 430SS and a dummy wafer DW4, which may be used to implement the sensor 130SS and the dummy wafer DW1 (or DW2, DW3), respectively.

In an embodiment, the inspection device 430 comprises an inspection stage 430STG, which serves as a holder to support the dummy wafer DW4 (or a wafer) for contact or non-contact measurements, and an end effector 430EE, which is configured to transfer the dummy wafer DW4 (or a wafer) within the inspection device 430. Corresponding to mark(s) on the dummy wafer DW4 (e.g., 4MK3), the end effector 430EE comprises a geometric feature 430H, which may be the existing appearance of the end effector 430EE, a through-hole, or a non-penetrating indentation, to facilitate easier or automatic recognition of the position of the end effector 430EE or the dummy wafer DW4. The inspection stage 430STG comprises an electrostatic chuck (E-chuck) 430CH, a plate 430 PT, a Z translation stage 430Z, and a XY translation stage 430XY, from top to bottom.

An automatic teaching method is suitable for the system 40 and may comprise the following steps:
Step S401: (The inspection device 430 maintains at an ambient air pressure.) Remove a vacuum robot maintain cover 430CV for a window of the inspection device 430. Place vacuum robot jig(s) 430J and the dummy wafer DW4 on the end effector 430EE, and secure the dummy wafer DW4 to the end effector 430EE. Mount the sensor 430SS on the inspection device 430 for the top chamber 430B.
Step S402: Put the vacuum robot maintain cover 430CV back. Check the functionality of the sensor 430SS and vacuum robot AWC function sensor(s) 430AWC.
Step S403: (A vacuum robot controller 430C1 of the inspection device 430 controls the end effector 430EE to rotate 180 degrees.) The vacuum robot controller 430C1 controls the end effector 430EE to slowly move the dummy wafer DW3 toward a load-unload position P4, configured for loading/unloading the dummy wafer DW4 or an actual wafer, without collision.
Step S404: The vacuum robot controller 430C1 moves the end effector 430EE until a wave from the sensor 430SS is aligned with the mark 4MK3. (For example, the value of the dummy wafer DW4 detected by the sensor 430SS is much greater than 0 or non-measurable due to no reflection.) When the wave(s) is/are directed at the mark 4MK3, which may be used to implement the mark 3MK3, in Step S404, the dummy wafer DW4 is at or near the load-unload position P4.

Noted that, the wave(s) from the sensor 430SS may be substantially directed towards a teaching position TP4 adjacent to the load-unload position P4. Since the small size of a window covered by the viewport cover 430V, which fails to cover the load-unload position P4, the sensor 430SS, which observes a top chamber 430B of the inspection device 430 through the viewport cover 430V, cannot be aimed at the load-unload position P4. Instead, the sensor 430SS is aimed at the teaching position TP4 (or the mark 4MK3 when the center of the dummy wafer DW4 eventually reaches the load-unload position P4).

In other words, the wave(s) can be used to guide to a predetermined position (e.g., the load-unload position P4). For example, as shown in FIG. 10, a wave from the 430SS may propagate substantially toward the teaching position TP4 adjacent to the load-unload position P4. Alternatively, as shown in FIG. 9, the reflection point of a wave from the sensor 430SS may be substantially the teaching position TP4 adjacent to the load-unload position P4.

To accurately locate or position the dummy wafer DW4, the position of the sensor 430SS relative to the inspection device 430 may correspond to the relative position of the mark 4MK3 relative to the dummy wafer DW4. For example, the mark 2MK1 is located between the center and the edge. As the distance between the teaching position TP4 and the load-unload position P4 equals to a shift value F4 (e.g., 90 or 100 mm), the distance between the wave(s) from the sensor 430SS and the load-unload position P4 or the distance between the mark 2MK1 and the center of the dummy wafer DW4 equals to the shift value F4. On the other hand, the radius of the dummy wafer DW4 (e.g., 140 mm) is larger than the shift value F4.
Step S405: The vacuum robot controller 430C1 moves the end effector 430EE back and forth along the Y axis in/near the top chamber 430B, such that a host computer 40HC of system 40 can locate two opposite edge-points of the mark 4MK3 according to edge indications of the sensor 430SS. The Y coordinates of the end effector 430EE, corresponding to the two opposite edge-points, are recorded (e.g., in the host computer 40HC) as Y_{C1} and Y_{C2}.
Step S406: The vacuum robot controller 430C1 moves the end effector 430EE back and forth back and forth along the X axis, such that the host computer 40HC can locate two opposite edge-points of the mark 4MK3 according to edge indications of the sensor 430SS. The X coordinates of the end effector 430EE, corresponding to the two opposite edge-points, are recorded (e.g., in the host computer 40HC) as X_{C1} and X_{C2}.
Step S407: The host computer 40HC determines that the X and Y coordinates (X_{C}, Y_{C}) of the end effector 430EE, for transferring the dummy wafer DW4 to the load-unload position P4, are the average of the X coordinates X_{C1}, X_{C2} and the average of the Y coordinates Y_{C1}, Y_{C2} plus the shift value F4. For example, it satisfies

$$( {X}_{C} , {Y}_{C} ) = ( \frac{{X}_{C 1} + {X}_{C 2}}{2} , \frac{{Y}_{C 1} + {Y}_{C 2}}{2} + F 4 ) .$$

In other words, the X and Y coordinates of the end effector 430EE is a function of the X and Y coordinates corresponding to the at least two opposite edge-points. For example, because of the limited installation position for the sensor 430SS, the teaching position TP4 is shifted from the load-unload position P4 by the shift value F4, and the shift value F4 should be compensated when calculating the Y coordinate Y_{C}.
Step S408: The host computer 40HC initially sets a passline PL4 for an initial height of the end effector 430EE when the sensor 430SS receives the reflection from the (top) surface of the dummy wafer DW4 and reads 0 mm. The vacuum robot controller 430C1 moves the end effector 430EE in the +Z direction to a position upper limit Z_{C1}, where the value detected by the sensor 430SS is −V4 (e.g., −4 mm). Given that the total path length is 2×V4 (e.g., 8 mm), a position lower limit Z_{C2} is set when the value detected by the sensor 430EE should be +V4 (e.g., +4 mm).
Step S409: The host computer 40HC determines the coordinates of the end effector 430EE is changed between (X_{C}, Y_{C}, Z_{C1}) and (X_{C}, Y_{C}, Z_{C2}) to place/remove the dummy wafer DW4 on/from the load-unload position P4.
Step S410: The host computer 40HC controls the end effector 430EE to leave the load-unload position P4 or move back to its home position. (Remove the vacuum robot jig(s) 430J from the end effector 430EE.) A stage controller 430C2 of the inspection device 430 moves the Z translation stage 430Z in the −Z direction to a default position, where the value detected by the sensor 430SS is, for example, 16.5 mm.
Step S411: The stage controller 430C2 moves the XY translation stage 430XY in the +X direction until the wave from the sensor 430SS just leaves the E-chuck 430CH. For example, when the wave from the sensor 430SS just skims an edge-point of the E-chuck 430CH, the value, which is detected by the sensor 430SS to serve as an edge indication, is, for example, 38.25 mm, and the X coordinate of the inspection stage 430STG is recorded (e.g., in the host computer 40HC) as X_{S1}. Similarly, the stage controller 430C2 moves the XY translation stage 430XY in the −X direction until the value detected by the sensor 430SS is, for example, 38.25 mm. Corresponding to the opposite edge-point of the E-chuck 430CH, the X coordinate of the inspection stage 430STG is recorded as X_{S2}.
Step S412: The host computer 40HC determines that the X coordinate X_{S} of the E-chuck 430CH, for transferring an actual wafer to the inspection stage 430STG, is the average of the X coordinates X_{S1}, X_{S2}. For example, it satisfies

$${X}_{S} = \frac{{X}_{S 1} + {X}_{S 2}}{2} .$$

Step S413: The stage controller 430C2 controls the XY translation stage 430XY to move the E-chuck 430CH to the position X_{S} without changing its height or Y coordinate.
Step S414: The stage controller 430C2 moves the XY translation stage 430XY in the −Y direction until the wave from the sensor 430SS just skims an edge-point of the E-chuck 430CH. The value detected by the sensor 430SS is, for example, 38.25 mm, and the Y coordinate of the inspection stage 430STG is recorded as Y_{S1}.
Step S415: The host computer 40HC determines that the Y coordinate Y_{S} of the E-chuck 430CH, for transferring an actual wafer to the inspection stage 430STG, is a function of the Y coordinate Y_{S1}. For example, it satisfies

$$( {X}_{S} , {Y}_{S} ) = ( \frac{{X}_{S 1} + {X}_{S 2}}{2} , {Y}_{S} + D 4 ) ,$$

where D4 represents the radius of the E-chuck 430CH. The radius D4 may be, for example, 161 mm.
Step S416: The end effector 430EE may load/unload the dummy wafer DW4 onto/from the E-chuck 430CH again, to check the overall movements.
Step S417: (Remove the sensor 430SS from the inspection device 430.)

The order of Steps S401-S417 may be rearranged, and at least one of S401-S417 or part of a step may be omitted.

The host computer 30HC may be or be used to implement the host computer 40HC. The vacuum robot controller 330C1 may be or be used to implement the vacuum robot controller 430C1.

Use of ordinal terms such as “first” and “second” does not by itself connote any priority, precedence, or order of one element over another, the chronological sequence in which acts of a method are performed, or the necessity for all the elements to be exist at the same time, but are used merely as labels to distinguish one element having a certain name from another element having the same name.

To sum up, with the assistance of sensor(s) near a holder and mark(s) of a dummy wafer, the coordinates of an end effector, corresponding to the center of the holder, can be obtained efficiently, accurately, and automatically. This allows the present invention to carry out position calculation and adjustment between an end effector of a device and a holder of another device, or between a device and a holder thereof.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An automatic teaching system, configured for teaching a position of a semiconductor wafer relative to a semiconductor system, wherein the semiconductor system comprises a first device and a second device, the first device comprises a holder, the second device comprises an end effector configured to transport the semiconductor wafer between the first device and the second device, and the automatic teaching system comprises:
a dummy wafer, comprising a mark, wherein the dummy wafer is or is to be either removed from the holder by the end effector or placed on the holder by the end effector; and
a first sensor, fixed to the first device, configured to determine a position of the dummy wafer by locating two opposite first edge-points of the mark after the end effector moves the dummy wafer back and forth along a first axis within the first device.

2. The automatic teaching system of claim 1, wherein a first coordinate of the dummy wafer in the first axis relative to the second device is determined according to a coordinate of one of the two opposite first edge-points or a coordinate of another of the two opposite first edge-points.

3. The automatic teaching system of claim 2,
wherein light from the first sensor is aligned or passed through the mark or a geometric feature of the end effector before the end effector moves the dummy wafer back and forth, and the opening of the end effector is positioned corresponding to the mark; or
the dummy wafer has a polar coordinate before the end effector moves the dummy wafer back and forth.

4. The automatic teaching system of claim 1, wherein the first sensor is configured to locate two opposite second edge-points of the mark after the end effector moves the dummy wafer back and forth along a second axis within the first device,
wherein a second coordinate of the dummy wafer in the second axis relative to the second device is a function of a coordinate of one of the two opposite second edge-points or a coordinate of another of the two opposite second edge-points.

5. The automatic teaching system of claim 1, wherein the first device is a load lock, the second device is an equipment front end module (EFEM), and the holder is at least one load lock pin;
wherein the first axis is a polar axis,
wherein a polar coordinate of the dummy wafer in the polar axis relative to the second device is determined according to a polar coordinate of one of the two opposite first edge-points and a polar coordinate of another of the two opposite first edge-points.

6. The automatic teaching system of claim 5, wherein the dummy wafer has a first coordinate and a second coordinate before the end effector moves the dummy wafer back and forth, and the automatic teaching system further comprises:
a second sensor, fixed to the first device, configured to determine the first coordinate and the second coordinate of the dummy wafer by detecting the mark or another mark on the dummy wafer.

7. The automatic teaching system of claim 1, wherein the mark is in a shape of a pill, a rectangle, or a circle;
wherein the mark is located either at a center of the dummy wafer, close to an edge of the dummy wafer, along a diameter of the dummy wafer, or perpendicular to the diameter of the dummy wafer;
wherein the mark is a through-hole or a non-penetrating indentation.

8. The automatic teaching system of claim 1, wherein the first sensor is configured to determine whether a height between the first sensor and the dummy wafer meets a predetermined value;
wherein the end effector is configured to transport the semiconductor wafer between a first position to a second position;
wherein the first position has a first coordinate, a second coordinate, and a first height equal to the predetermined value plus a first offset value;
wherein the second position has, the first coordinate, the second coordinate, and a second height equal to the predetermined value minus the first offset value.

9. The automatic teaching system of claim 1, wherein the first device is a load lock, the second device is an inspection device, and the holder is at least one load lock pin;
wherein the dummy wafer is secured to the end effector using at least one vacuum robot jig;
wherein the end effector comprises at least one geometric feature corresponding to the at least one vacuum robot jig, and the at least one geometric feature is at least one through-hole or at least one non-penetrating indentation.

10. The automatic teaching system of claim 1, wherein the first device and the second device constitute an inspection device, and the holder is a stage;
wherein the first sensor is configured to locate two opposite fourth edge-points of the electrostatic chuck after the holder moves back and forth along the first axis, a fourth coordinate of the holder in the first axis relative to the first device is determined according to a coordinate of one of the two opposite fourth edge-points and a coordinate of another of the two opposite fourth edge-points;
wherein the first sensor is configured to locate a fifth edge-point of the electrostatic chuck after the holder moves along a second axis within the first device, a fifth coordinate of the holder in the second axis relative to the first device is determined according to a coordinate of the fifth edge-point;
wherein the holder is configured to move toward a third position having the fourth coordinate, the fifth coordinate, and a first height equal to a predetermined value plus a second offset value.

11. An automatic teaching method, for teaching a position of a semiconductor wafer relative to a semiconductor system, wherein the semiconductor system comprises a first device and a second device, the first device comprises a holder, the second device comprises an end effector configured to transport the semiconductor wafer between the first device and the second device, and the automatic teaching method comprises:
determining, by a first sensor, a position of a dummy wafer by locating two opposite first edge-points of the mark after the end effector moves the dummy wafer back and forth along a first axis within the first device, wherein the dummy wafer is or is to be either removed from the holder by the end effector or placed on the holder by the end effector, the first sensor is fixed to the first device; and
outputting, by the first sensor, information about the position of the dummy wafer.

12. The automatic teaching method of claim 11, wherein a first coordinate of the dummy wafer in the first axis relative to the second device is determined according to a coordinate of one of the two opposite first edge-points or a coordinate of another of the two opposite first edge-points.

13. The automatic teaching method of claim 12,
wherein light from the first sensor is aligned or passed through the mark or a geometric feature of the end effector before the end effector moves the dummy wafer back and forth, and the opening of the end effector is positioned corresponding to the mark; or
the dummy wafer has a polar coordinate before the end effector moves the dummy wafer back and forth.

14. The automatic teaching method of claim 11, wherein the step of determining the position of the dummy wafer comprises:
locating, by the first sensor, two opposite second edge-points of the mark after the end effector moves the dummy wafer back and forth along a second axis within the first device, wherein a second coordinate of the dummy wafer in the second axis relative to the second device is a function of a coordinate of one of the two opposite second edge-points or a coordinate of another of the two opposite second edge-points.

15. The automatic teaching method of claim 11, wherein the first axis is a polar axis,
wherein a polar coordinate of the dummy wafer in the polar axis relative to the second device is determined according to a polar coordinate of one of the two opposite first edge-points and a polar coordinate of another of the two opposite first edge-points;
wherein the first device is a load lock, the second device is an equipment front end module (EFEM), and the holder is at least one load lock pin.

16. The automatic teaching method of claim 15, wherein the dummy wafer has a first coordinate and a second coordinate before the end effector moves the dummy wafer back and forth;
wherein a second sensor fixed to the first device is configured to determine the first coordinate and the second coordinate of the dummy wafer by detecting the mark or another mark on the dummy wafer.

17. The automatic teaching method of claim 11, wherein the mark is in a shape of a pill, a rectangle, or a circle;
wherein the mark is located either at a center of the dummy wafer, close to an edge of the dummy wafer, along a diameter of the dummy wafer, or perpendicular to the diameter of the dummy wafer;
wherein the mark is a through-hole or a non-penetrating indentation.

18. The automatic teaching method of claim 11, wherein the step of determining the position of the dummy wafer comprises:
determining, by the first sensor, whether a height between the first sensor and the dummy wafer meets a predetermined value;
wherein the end effector is configured to transport the semiconductor wafer between a first position to a second position;
wherein the first position has a first coordinate, a second coordinate, and a first height equal to the predetermined value plus a first offset value;
wherein the second position has the first coordinate, the second coordinate, and a second height equal to the predetermined value minus the first offset value.

19. The automatic teaching method of claim 11, wherein the first device is a load lock, the second device is an inspection device, and the holder is at least one load lock pin;
wherein the dummy wafer is secured to the end effector using at least one vacuum robot jig;
wherein the end effector comprises at least one geometric feature corresponding to the at least one vacuum robot jig, and the at least one geometric feature is at least one through-hole or at least one non-penetrating indentation.

20. The automatic teaching method of claim 11, wherein the first device and the second device constitute an inspection device, and the holder is a stage;
wherein the first sensor is configured to locate two opposite fourth edge-points of the electrostatic chuck after the holder moves back and forth along the first axis, a fourth coordinate of the holder in the first axis relative to the first device is determined according to a coordinate of one of the two opposite fourth edge-points and a coordinate of another of the two opposite fourth edge-points;
wherein the first sensor is configured to locate a fifth edge-point of the electrostatic chuck after the holder moves along a second axis within the first device, a fifth coordinate of the holder in the second axis relative to the first device is determined according to a coordinate of the fifth edge-point;
wherein the holder is configured to move toward a third position having the fourth coordinate, the fifth coordinate, and a first height equal to a predetermined value plus a second offset value.
